(19) United States
(12) Patent Application Publication
(10) Pub. No.: US 2026/0265423 A1
(43) Pub. Date: Sep. 10, 2026

(54) GLASSY GELS TOUGHEND BY SOLVENT

(71) Applicant: North Carolina State University, Raleigh, NC (US)

(72) Inventors: Michael D. Dickey, Raleigh, NC (US); Meixiang Wang, Beijing (CN)

(21) Appl. No.: 19/421,385

(22) Filed: Dec. 16, 2025

Related U.S. Application Data
(60) Provisional application No. 63/767,019, filed on Mar. 5, 2025.

(51) Int. Cl. C08F 20/06; C08F 20/28

(52) U.S. Cl. CPC C08F 20/06; C08F 20/28; C08F 2800/10; C08F 2810/20; C08F 2810/50

(57) ABSTRACT

The present invention provides a glassy gel including a polymer and an ionic liquid. The glassy gel has a toughness greater than 10 MJ/m³. Glassy gels exhibit a combination of properties that include the capability to be strained like a gel, a fracture strength similar to a brittle glassy polymer, and toughness greater than either a gel or a brittle glassy polymer.

### CROSS-REFERENCE

This application claims the benefit of U.S. Provisional Patent Application Ser. No. 63/767,019 filed on Mar. 5, 2025, which is incorporated herein by reference in its entirety.

### TECHNICAL FIELD

The invention relates generally to polymers. The invention particularly relates to making glassy gels comprising a polymer and an ionic liquid to obtain a material that exhibits strong mechanical properties like a glassy polymer, as well as stretchability like a gel.

### BACKGROUND

The excellent mechanical properties of glassy polymers are critical for many consumer products. Due to the strong interactions between polymer chains in the absence of solvent, glassy polymers are significantly stiffer (≈1 GPa modulus) and stronger (≈10-100 MPa fracture strength) than most gels (e.g., ≈0.0001 GPa modulus and <1 MPa fracture strength). Yet, the high loading of solvent and thus, increased free volume (i.e., volume not occupied by polymer) found in gels can provide benefits. For example, increasing the stretchability of polymer networks by 1-2 orders of magnitude relative to glassy polymers while providing additional functionality, such as serving as an electrolyte. Importantly, solvating a glassy polymer to render it a gel decreases the polymer-polymer interactions and softens the polymer network, thereby diminishing the mechanical properties.

There is a need to develop materials that have both the mechanical properties of a glassy polymer and the stretchability of gel. There is a need to develop materials having self-healing and shape-memory properties. There is a need to develop materials that have thermal stability and adhesive properties. There is a need for a simple and versatile route to make polymeric parts or coatings on demand with attractive properties of gels (high solvation, large elongation), glasses (stiffness, strength), thermoplastics (toughness), crosslinked networks (strain recovery), and ionic liquids (nonvolatility, conductivity).

### SUMMARY OF THE INVENTION

In some aspects, the techniques described herein relate to a glassy gel including:
(a) a polymer; and (b) an ionic liquid. The glassy gel has a toughness greater than 10 MJ/m³. The glassy gel is homogeneous at room temperature.

In some aspects, the techniques described herein relate to a glassy gel including: (a) an ionic liquid (b) a residue of a monomer; and (c) a residue of a polymer initiator. The glassy gel has a toughness greater than 10 MJ/m³. The monomer includes acrylic acid (AA), 2-hydroxyethyl methacrylate (HEMA), acrylamide (AAm), and/or N, N-dimethylacrylamide (DMAAm). The ionic liquid includes a phosphonium-based ionic liquid, an imidazolium-based ionic liquid, a pyridinium-based ionic liquid, a pyrrolidinium-based ionic liquid, and/or a quaternary ammonium-based ionic liquid.

In some aspects, the techniques described herein relate to a process for making a glassy gel, the process including: (a) combining a monomer, a polymerization initiator and an ionic liquid to form a solution; and (b) applying an activator of the polymerization initiator to the solution. The glassy gel has a toughness greater than 10 MJ/m³. The glassy gel is homogeneous at room temperature.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1a is a schematic drawing showing relative mechanical properties of PAA-PP-6M glassy gels compared to PAA glassy polymers and PAA-Water-6M gels.

FIG. 1b is a graph of stress versus strain for the PAA-PP glass gels at varied monomer concentrations.

FIG. 1c is a graph of Young's modulus and yield strength versus monomer molar concentration of the PAA-PP glassy gels.

FIGS. 1d and 1e, show comparisons of Young Modulus and fracture strength, respectively, between glassy gels and many other substances.

FIG. 2a is a graph of the temperature dependance of the loss tangent (tan δ) of the PAA-PP glassy gels with monomer concentration ranging from 4 M to 6.5 M.

FIG. 2b is a graph of the tensile stress-strain curves of gels for PAA-PP-6 M made with and without MBAA, the covalent crosslinker.

FIG. 2c is a graph of the Fourier Transform Infrared Spectroscopy (FTIR) for PP, AA, AA-PP-5.5 M precursor, and PAA-PP-5.5 M.

FIG. 2d is the same FTIR graph as FIG. 2c with the wavenumber expanded between 1600 cm⁻¹ and 800 cm⁻¹.

FIG. 2e is a graph of a ¹³C NMR spectra of PP solvent, AA monomer, and their mixture (Cm=6 M).

FIG. 3a is graph of the normalized Young's modulus, fracture strain, and toughness of each sample as a function of the molar ratio of monomer (AA) to IL solvent (PP), n_{AA}/n_{PP}.

FIG. 3b is a schematic drawing of the molecular structure of the material at different ratios of n_{AA}/n_{PP}.

FIG. 3c is a graph of the stress-strain curve of a glassy gel, PAA-PP-6 M, divided into four regimes.

FIG. 3d is a series of schematic drawings showing the deformation mechanism of a glassy gel during elongation.

FIG. 4a is a graph of tensile stress-strain curves of PAA gels with different ionic liquids.

FIG. 4b is graph of the normalized Young's modulus, fracture strain, and toughness as a function of the molar ratio of monomer (AA) to IL solvent (NS), n_{AA}/n_{NS}.

FIG. 4c is a graph showing the tensile stress-strain curves of PHEA-PP-6 M and PHEMA-PP-5.5 M.

FIG. 4d is a graph of the normalized toughness of PHEA-PP and PHEMA-PP gels as a function of the molar ratio of monomer to PP (nₘₒₙₒₘₑᵣ/n_{PP}).

FIG. 5a is a schematic drawing comparing the Young's modulus and fracture strain for a glassy polymer, a glassy gel, and a gel.

FIG. 5b is a graph of the stress-strain curves for PAA-PP-6M glassy gel, PAA glassy polymer, and PAA-Water-6M gel made in Example 1.

FIG. 5c is a spider plot summary in terms of liquid content, toughness, recovery, fracture strength, and elongation.

FIG. 6a is a schematic drawing of a non-limiting process for making PAA-PP glassy gels.

FIG. 6b is a graph of transmission of various gels.

FIG. 6c is a graph of normalized weight over a period of thirty days for various gels.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is to be understood that the mention of one or more method steps does not preclude the presence of additional method steps before or after the combined recited steps or intervening method steps between those steps expressly identified. Moreover, the lettering of method steps or ingredients is a conventional means for identifying discrete activities or ingredients and the recited lettering can be arranged in any sequence, unless otherwise indicated.

As used herein, the term “and/or”, when used in a list of two or more items, means that any one of the listed items can be employed by itself, or any combination of two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the term “polymerization initiator” refers to a compound that upon exposure to light or exposure to heat generates reactive species that start a polymerization reaction. As used herein, the term “photoinitiator” refers to a compound that generates reactive species that start a polymerization reaction upon exposure to light. As used herein, the term “thermal initiator” refers to a compound that generates reactive species that start a polymerization reaction upon exposure to heat.

As used herein, the term “ionogels” refers to gels made with ionic liquids dispersed in a solid matrix, typically a polymer. As used herein, the term “glassy gels” refers to a subset of “ionogels” with a combination of properties that include the capability to be strained like a gel, a fracture strength similar to a brittle glassy polymer, and toughness greater than either a gel or a brittle glassy polymer.

As used herein, the term “homogenous,” as in a “homogenous glassy gel,” refers to a glassy gel with uniform composition throughout the material. The difference between a “homogeneous glassy gel” and a heterogeneous glassy gel can also be distinguished under microscopy by a difference in transparency and/or visual signs of polymer phase separation and by a single glass transition temperature, T_{g}.

As used herein, the term “fluorinated ionic liquids” refers to a specific type of ionic liquid where a significant portion of the molecule's structure contains fluorine atoms, often incorporated into the cation or anion, giving the liquid unique properties like enhanced gas solubility, low viscosity, and high chemical stability.

In some aspects, the techniques described herein relate to a glassy gel including: (a) a polymer; and (b) an ionic liquid. The glassy gel has a toughness greater than 10 MJ/m³. The glassy gel is homogeneous at room temperature.

In some aspects, the polymer comprises residues of a monomer, and the monomer is soluble in the ionic liquid.

In some aspects, the polymer further comprises, a crosslinker, a filler, and/or residues of a polymerization initiator.

In some aspects, the monomer comprises acrylic acid (AA), 2-hydroxyethyl methacrylate (HEMA), acrylamide (AAm), and/or N,N-dimethylacrylamide (DMAAm).

In some aspects, the ionic liquid comprises a phosphonium-based ionic liquid, an imidazolium-based ionic liquid, a pyridinium-based ionic liquid, a pyrrolidinium-based ionic liquid, and/or a quaternary ammonium-based ionic liquid. In some aspects, the ionic liquid is hydrophobic and comprises a fluorinated ionic liquid.

In some aspects, the crosslinker comprises N, N′-methylenebis(acrylamide) (MBAA). In some aspects, the polymerization initiator comprises 2-hydroxy-4′-(2-hydroxyethoxy)-2-methylpropiophenone.

In some aspects, a molar ratio of the monomer to the ionic liquid, nm: nil, ranges from 2:1 to 6:1. In some aspects, the glassy gel comprises 40 wt. % to 70 wt. % of the ionic liquid on a total glassy gel weight basis.

In some aspects, the toughness ranges from 10 MJ/m³ to 110 MJ/m³.

In some aspects, the glassy gel has a fracture strength ranging from 5 MPa to 42 MPa, the glassy gel has a yield strength ranging from 5 MP to 95 MP, and the glassy gel has a Young's modulus ranging from 50 MPa to 1 GPa.

In some aspects, the glassy gel can be strained by a stress, the strain can reach up to 100%, and the glassy gel returns to its original shape after the stress is removed and the glassy gel is subjected to 80° C. for at least one minute.

In some aspects, the glassy gel has adhesive properties, shape memory properties, and/or self-healing properties

In some aspects, the polymer comprises residues of a monomer, and the monomer is soluble in the ionic liquid. In some aspects, the polymer further comprises residues of a polymerization initiator. In some aspects, the polymerization initiator is selected from the group consisting of a photoinitiator or a thermal initiator.

In some aspects, the glassy gel further comprises a crosslinker. In some aspects, the glassy gel further comprises a filler.

In some aspects, the ionic liquid comprises a phosphonium-based ionic liquid, an imidazolium-based ionic liquid, pyridinium-based ionic liquid, a pyrrolidinium-based ionic liquid, and/or a quaternary ammonium-based ionic liquid. In some aspects, the ionic liquid comprises tributyl(methyl)phosphonium dimethyl phosphate (PP), tributyl(methyl)phosphonium methyl sulfate (PS), 1-ethyl-3-methylimidazolium dimethyl phosphate (NP), and/or 1-ethyl-3-methylimidazolium ethyl sulfate (NS).

In some aspects, the ionic liquid is hydrophobic. In some aspects, the ionic liquid is hydrophobic and comprises a fluorinated ionic liquid. In some aspects, the ionic liquid is hydrophobic and comprises 1-ethyl-3-methylimidazolium bis(trifluoromethylsulfonyl) imide ionic liquid.

In some aspects, the toughness ranges from 10 MJ/m³ to 110 MJ/m³; or from 20 MJ/m³ to 110 MJ/m³; or from 30 MJ/m³ to 110 MJ/m³; or from 10 MJ/m³ to 90 MJ/m³; or from 20 MJ/m³ to 90 MJ/m³; or from 30 MJ/m³ to 90 MJ/m³.

In some aspects, the glassy gel has a fracture strength ranging from 5 MPa to 42 MPa; or from 5 MPa to 40 MPa; or from 5 MPa to 35 MPa; or from 5 MPa to 30 MPa; or from 10 MPa to 42 MPa; or from 10 MPa to 30 MPa; or from 10 MPa to 35 MPa; or from 10 MPa to 30 MPa.

In some aspects, the glassy gel has a yield strength ranging from 5 MP to 95 MP; or from 5 MP to 90 MP; or from 5 MP to 70 MP; or from 5 MP to 60 MP; or from 5 MPa to 50 MPa; or from 5 MPa to 40 MPa; or from 5 MPa to 30 MPa; from 5 MP to 73 MP; or from 5 MP to 70 MP; or from 5 MP to 60 MP; or from 5 MP to 50 MP; or from 5 MPa to 40 MPa; or from 5 MPa to 35 MPa; or from 5 MPa to 30 MPa; 10 MP to 74 MP; or from 10 MP to 70 MP; or from 10 MP to 60 MP; or from 10 MP to 50 MP; or from 10 MPa to 40 MPa; or from 10 MPa to 35 MPa; or from 10 MPa to 30 MPa.

In some aspects, the glassy gel has a Young's modulus ranging from 50 MPa to 1 GPa; or from 100 MPa to 1 GPa; or from 150 MPa to 1 GPA; or from 200 MPa to 1 GPa; or from 50 MPa to 900 MPa; or from 100 MPa to 900 MPa; or from 150 MPa to 900 MPa; or from 200 MPa to 900 MPa.

In some aspects, the glassy gel can be strained by a stress, wherein the strain can reach up to 100%; or up to 150%; or up to 200%; or up to 250%; or up to 300%; or up to 350%; or up to 400%; or up to 450%; or up to 500%; or up to 550%; or up to 600%; or up to 650%; or up to 670%; or up to 700%. In some aspects, the glassy gel returns to its original shape after the stress is removed. In some aspects, the glassy gel returns to its original shape after the stress is removed and the glassy gel is subjected to 80° C. for at least one minute, or for at least 3 minutes, or for at least 5 minutes.

In some aspects, the glassy gel has a transmittance of greater than 90%, or greater than 95% when measured on a rectangular sample (width=20 mm, length=50 mm, thickness=2 mm) using a UV-Vis-NIR spectrometer (PE Lambda 950, Perkin Elmer) with a wavelength range of 400-800 nm.

In some aspects, the glassy gel placed in ambient conditions for a period of 2 weeks, maintains at least 95 percent, 98 percent, or 99 percent of an original weight.

In some aspects, a molar ratio of the monomer to the ionic liquid, nm: nil, ranges from 2:1 to 6:1, or from 2:1 to 5:1, or from 2:1 to 4.5:1, or from 3:1 to 6:1, or from 3:1 to 5:1, or from 3:1 to 4.5:1.

In some aspects, the glassy gel comprises 40 wt. % to 70 wt. %, or 40 wt. % to 65 wt. %, or 40 wt. % to 60 wt. %, or 45 wt. % to 70 wt. %, or 45 wt. % to 65 wt. %, or 45 wt. % to 60 wt. %, or 50 wt. % to 70 wt. %, or 50 wt. % to 65 wt. %, or 50 wt. % to 60 wt. % of the ionic liquid on a total glassy gel weight basis.

In some aspects. the glassy gel has adhesive properties, shape memory properties, and/or self-healing properties. In some aspects, the glassy gel is used as a Joule heat-driven gripper in electronics, batteries, or sensors.

In some aspects, the ionic liquid is biocompatible. In some aspects, the ionic liquid is biocompatible and comprises a mix of choline and lactic acid. In some aspects, the ionic liquid is biocompatible and comprises 1-butyl-3-methylimidazolium chloride.

In some aspects, upon formation of a solution of the monomer in the ionic liquid, a temperature of the solution increases at least 1° C.

In some aspects, the techniques described herein relate to a glassy gel including: (a) an ionic liquid (b) a residue of a monomer; and (c) a residue of a polymer initiator. The glassy gel has a toughness greater than 10 MJ/m³. The monomer includes acrylic acid (AA), 2-hydroxyethyl methacrylate (HEMA), acrylamide (AAm), and/or N,N-dimethylacrylamide (DMAAm). The ionic liquid includes a phosphonium-based ionic liquid, an imidazolium-based ionic liquid, pyridinium-based ionic liquid, a pyrrolidinium-based ionic liquid, and/or a quaternary ammonium-based ionic liquid.

In some aspects, the glassy gel is homogeneous at room temperature.

In some aspects, the monomer comprises acrylic acid (AA) and/or 2-hydroxyethyl methacrylate (HEMA), and the ionic liquid comprises tributyl(methyl)phosphonium dimethyl phosphate (PP), tributyl(methyl)phosphonium methyl sulfate (PS), 1-ethyl-3-methylimidazolium dimethyl phosphate (NP), and/or 1-ethyl-3-methylimidazolium ethyl sulfate (NS).

In some aspects, a molar ratio of the monomer to the ionic liquid, nm: nil, ranges from 2:1 to 6:1, and the glassy gel comprises 40 wt. % to 70 wt. % of the ionic liquid on a total glassy gel weight basis.

In some aspects, the toughness ranges from 10 MJ/m³ to 110 MJ/m³, the glassy gel has a fracture strength ranging from 5 MPa to 42 MPa wherein the glassy gel has a yield strength ranging from 5 MP to 95 MP, and the glassy gel has a Young's modulus ranging from 50 MPa to 1 GPa.

In some aspects, the glassy gel can be strained by a stress, the strain can reach up to 100%, and the glassy gel returns to its original shape after the stress is removed and the glassy gel is subjected to 80° C. for at least one minute.

In some aspects, the glassy gel has adhesive properties, shape memory properties, and/or self-healing properties.

In some aspects, the techniques described herein relate to a process for making a glassy gel, the process including: (a) combining a monomer, a polymerization initiator and an ionic liquid to form a solution; and (b) applying an activator of the polymerization initiator to the solution. The glassy gel has a toughness greater than 10 MJ/m³. The glassy gel is homogeneous at room temperature.

In some aspects, the polymerization initiate comprises a photoinitiator and/or a thermal initiator and the activator comprises UV radiation (e.g., light) and/or heat. In some aspects, the polymerization initiate comprises a photoinitiator and the activator comprises UV radiation (e.g., light). In some aspects, the polymerization initiate comprises a thermal initiator and the activator comprises heat.

In some aspects, step a) further comprises combining a crosslinker.

In some aspects, step a) further comprises combining a filler.

In some aspects, the techniques described herein relate to a process for making a glassy gel, the process including: (a) combining a polymer, an ionic liquid, and a solvent to form a solution; and (b) removing the solvent from the solution to form the glassy gel.

In some aspects, the solvent is removed via evaporation. In some aspects, step a) further comprises combining a crosslinker. In some aspects, step a) further comprises combining a filler.

### EXAMPLES

Monomers of (acrylic acid) AA, 2-hydroxyethyl acrylate (HEA), 2-hydroxyethyl methacrylate (HEMA), acrylamide (AAm), and N,N-Dimethylacrylamide (DMAAm), butyl acrylate (BA), the covalent crosslinker of N, N′-methylenebis(acrylamide) (MBAA), the ionic liquids of tributyl(methyl)phosphonium dimethyl phosphate (PP), tributyl(methyl)phosphonium methyl sulfate (PS), 1-ethyl-3-methylimidazolium dimethyl phosphate (NP), and 1-ethyl-3-methylimidazolium ethyl sulfate (NS), and the photoinitiator of 2-hydroxy-4′-(2-hydroxyethoxy)-2-methylpropiophenone (Irgacure 2959) were purchased from Sigma and used as received without further purification.

We fabricated a series of gels with the nomenclature PM-S-Cₘ, where M, S, and Cₘ is the monomer, solvent, and molar concentration of monomer, respectively. P stands for ‘poly’ as in polymer. For example, PAA-PP-4 M gel is prepared by polymerizing 4 M AA in PP solvent.

M echanical measurements. Tensile properties were measured using a tensile-compressive tester (Instron 5943) at a deformation rate of 100 mm min⁻¹. For recovery testing, the sample was first loaded to a certain strain and then unloaded to zero force at a constant velocity of 100 mm min⁻¹. The sample was then stored at 80° C. for 1 min to recover. After cooling the sample to RT, its tensile stress-strain curve was recorded. Mechanical stability was measured by storing the samples under vacuum at 80° C. and tensile stress-strain curves (deformation rate=100 mm min⁻¹) at RT were recorded for different durations. Dog-bone-shaped samples with a length of 35 mm, width of 2 mm, and gauge length of 12 mm were used in the tensile, recovery and mechanical stability tests. The fracture strength and fracture strain were obtained from the failure point of the tensile stress-strain curve, respectively. For gels with a yield point, their modulus was determined by the slope of the linear elastic region (generally ≤5% strain). For gels without a yield point, their modulus was determined from the slope of the first 10% strain of the stress-strain curve.

Nuclear magnetic resonance (NMR) test. ¹³C NMR spectra of various monomers, ILs, and their mixtures in CDCl₃ were recorded using Bruker Avance III 700 MHz NMR.

FTIR test. The chemical structures of various materials were analyzed using FTIR spectroscopy (Spectrum Two FT-IR Spectrometer, Perkin Elmer). All spectra were measured in transmission mode, with data recorded in the range of 4000-800 cm⁻¹ over 16 scans.

Transmittance test. Rectangle samples (width=20 mm, length=50 mm, thickness=2 mm) were used to measure the transmittance of various gels using a UV-Vis-NIR spectrometer (PE Lambda 950, Perkin Elmer) with a wavelength range of 400-800 nm.

Stability test. Disc-shaped gel samples (thickness=2 mm, diameter=12 mm) were prepared and their weight changes over time at RT were recorded. To achieve adequate precision, three samples were measured

### Example 1

The glassy gels were fabricated by a one-step polymerization. In a typical procedure, a specified concentration of AA (e.g., Cₘ=6 M), covalent crosslinker of MBAA (0.1 mol %, in a concentration relative to Cₘ), and photoinitiator of I2959 (0.05 mol %, in a concentration relative to Cₘ) were dissolved in PP to form a uniform solution. The solution was then poured into a mold with two pieces of glasses separated by a spacer and then cured under ultraviolet light (Intelliray 400, ≈60 mW cm⁻²) for 5 mins to obtain the glassy gels. PAA gel was synthesized in the same manner only with water substituted for the PP. PAA glassy polymer was synthesized by curing AA monomer in water without MBAA, followed by drying at 100° C. until its weight is constant. Pieces of the glassy polymer and glassy gel where molded to a length, width, and height of 15, 1.5 and 10 mm and a piece of the gel was molded to length, width, and height of 15, 10, and 10 mm. The monomer concentration was 6 M for the glassy gel and gel, while the liquid content of the glassy polymer, glassy gel, and gel was 0, 58, and 56 wt. %, respectively.

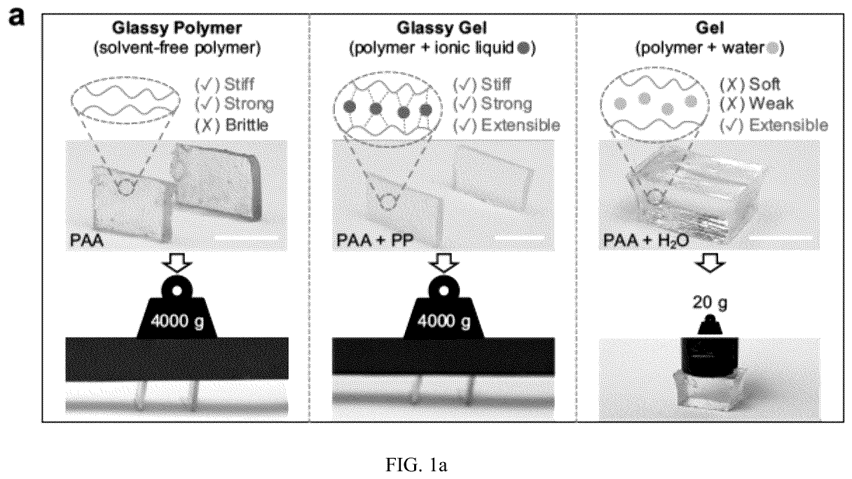

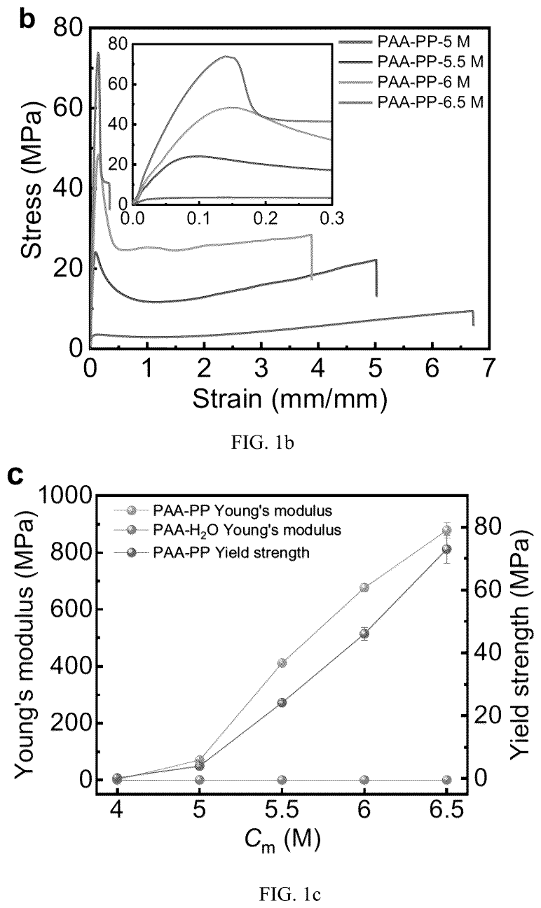

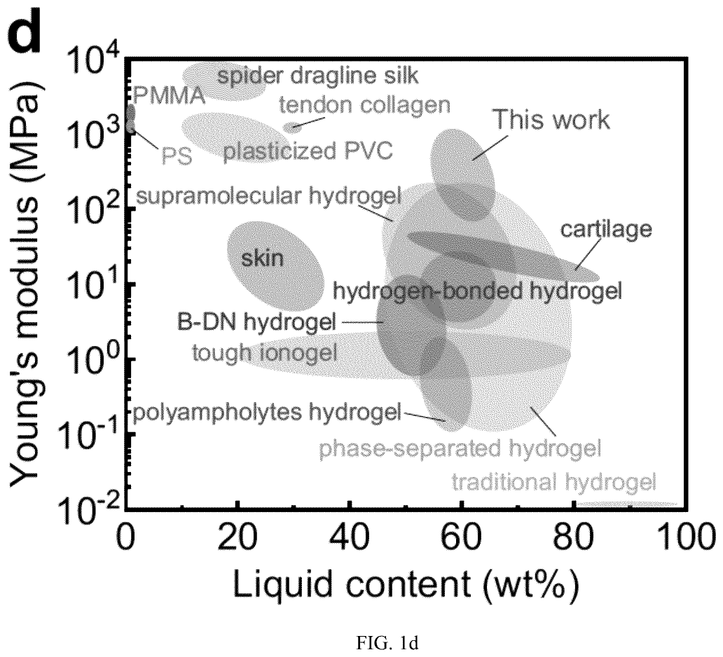

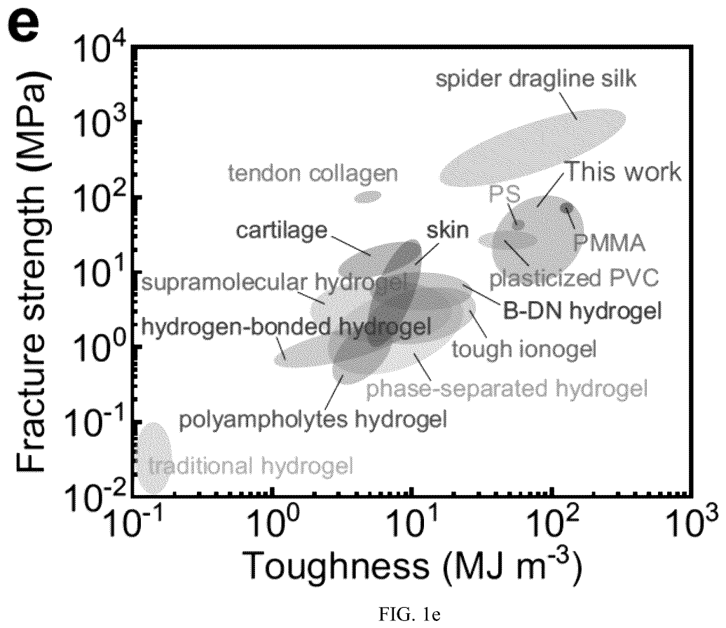

FIG. 1a is a schematic drawing showing relative mechanical properties of PAA-PP-6M glassy gels compared to PAA glassy polymers and PAA-Water-6M gels. In FIG. 1a the PAA glassy polymer is solvent-free, stiff and strong, but brittle. The PAA-PP-6M glassy gel is physically crosslinked by the ionic liquid solvent and becomes stiff, strong and extensible, whereas the PAA-Water-6M gel lacks solvent crosslinking and becomes soft and weak, but extensible. As a result, the PAA glassy polymer and PAA-PP-6M glassy gel can hold 4,000 g, whereas the gel can only hold up to 20 g despite being about seven times wider. The scale bar is 10 mm.

### Example 2

The procedure for making glassy gels in Example 1 was repeated with AA as the monomer and PP as the ionic liquid, but with varying the molar concentration to make PAA-PP-4 M, PAA-PP-5 M, PAA-PP-5.5 M, and PAA-PP-6.5 M. Also, another sample of PAA-PP-6 was made as in Example 1, but without using the MBAA crosslinker. FIG. 1b is a graph of stress versus strain for the PAA-PP glass gels at the varied monomer concentrations. Tensile stress-strain behavior is highly composition dependent (inset, the magnification of b). FIG. 1c is a graph of Young's modulus and yield strength versus monomer molar concentration of the PAA-PP glassy gels. Error bars on the data show standard deviation from three independent samples.

FIGS. 1d and 1e, show comparisons of Young Modulus and fracture strength, respectively, between glassy gels and many other substances. Comparison of this work and various gels, glassy and plasticized polymers, biological tissues such as skin, cartilage, tendon collagen, and spider dragline silk in terms of Young's modulus and liquid content (FIG. 1d) and fracture strength and toughness (FIG. 1e).

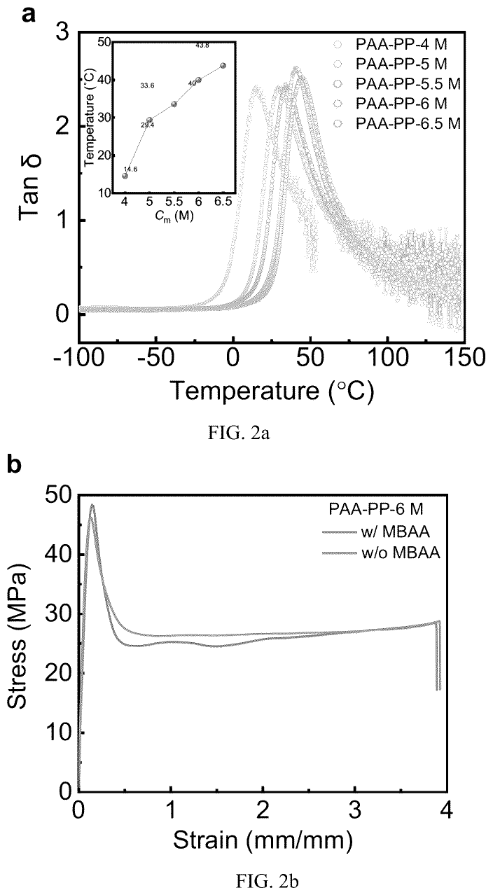

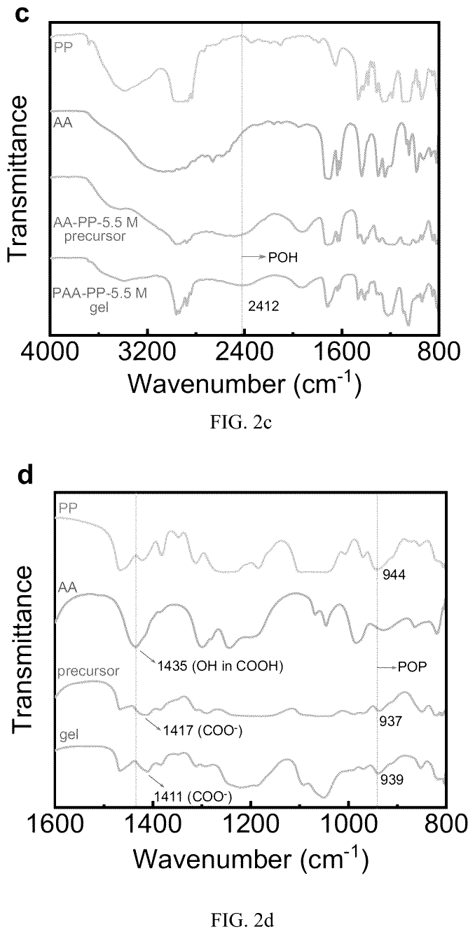

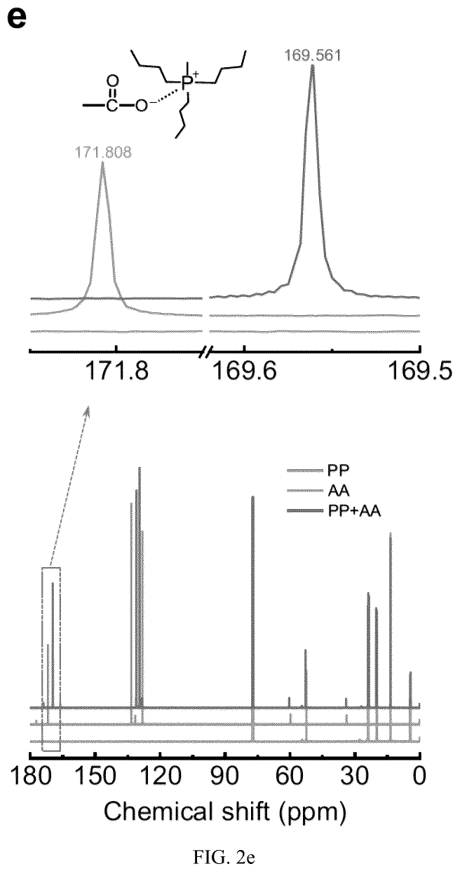

FIG. 2a is a graph of the temperature dependance of the loss tangent (tan δ) of the PAA-PP glassy gels with Cₘ ranging from 4 M to 6.5 M. FIG. 2b shows the tensile stress-strain curves of gels for PAA-PP-6 M made with and without MBAA, the covalent crosslinker. FIG. 2c is a graph of the Fourier Transform Infrared Spectroscopy (FTIR) for PP, AA, AA-PP-5.5 M precursor and PAA-PP-5.5 M. FIG. 2d is the same FTIR graph as FIG. 2c with the wavenumber expanded between 1600 cm⁻¹ and 800 cm⁻¹. FIG. 2e is ¹³C NMR spectra of PP solvent, AA monomer, and their mixture (Cm=6 M). The top of FIG. 2e is the zoomed-in ¹³C NMR spectra of carbon in the carboxyl group of AA.

### Example 3

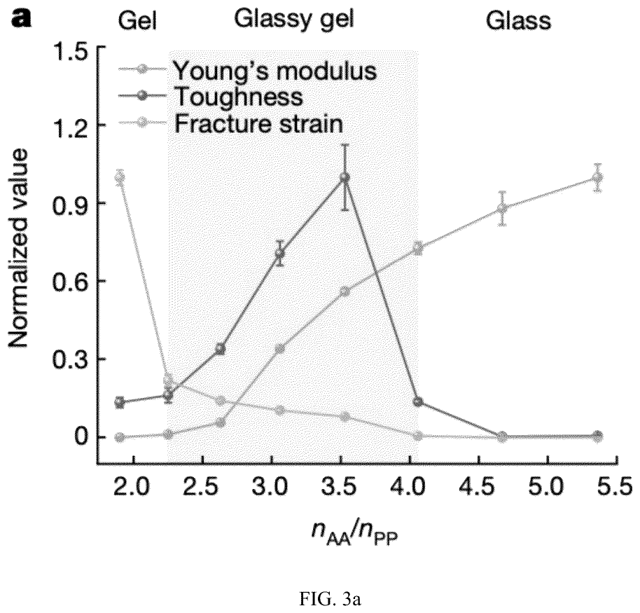

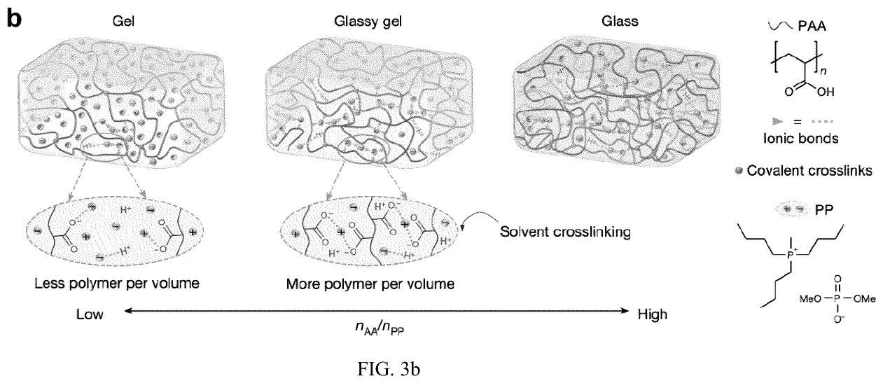

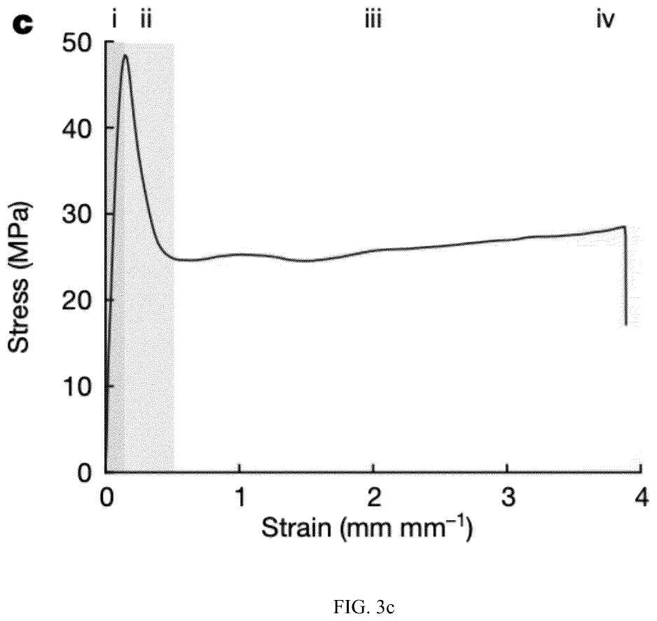

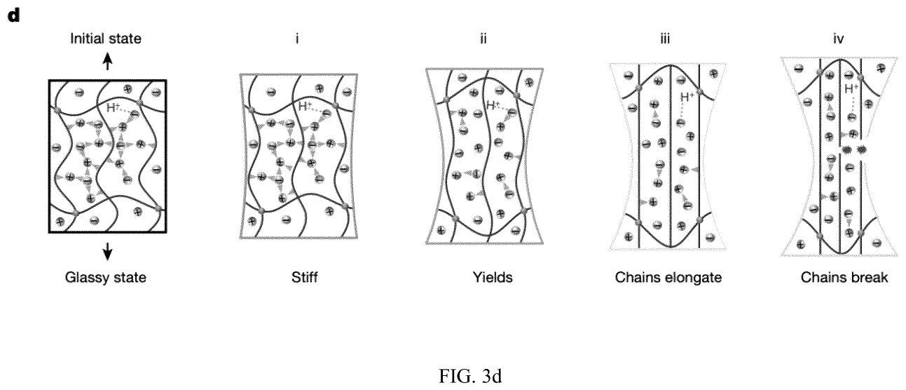

Example 1 was repeated with the AA monomer, PP ionic liquid, with the ratio of moles of AA to moles of PP (n_{AA}/n_{PP}) ranging from below 2 to below 5.5. FIG. 3a is graph showing the normalized Young's modulus, fracture strain, and toughness of each sample as a function of the molar ratio of monomer (AA) to IL solvent (PP), n_{AA}/n_{PP}. Error bars on the data show standard deviation from three independent samples. As the molar ratio changes, the mechanical behavior of the samples varies from soft and stretchable (gel-like), stiff and tough (glassy gel), to stiff and brittle (glass-like). FIG. 3b is a schematic drawing of the molecular structure of the material at different ratios of n_{AA}/n_{PP}. When n_{AA}/n_{PP} is low, the chains are separated by excess solvent, resulting in a soft gel. As molar ratio increases, more solvent crosslinks form between chains, resulting in a glassy gel. Further increasing n_{AA}/n_{PP} results in sufficient crosslinks to form a stiff network, but insufficient solvent to give extensibility; thus, a brittle glass.

FIG. 3c is a graph of the stress-strain curve of a glassy gel, PAA-PP-6 M divided into four regimes. FIG. 3d is a series of schematic drawings showing the deformation mechanism of the glassy gel during elongation.

### Example 4

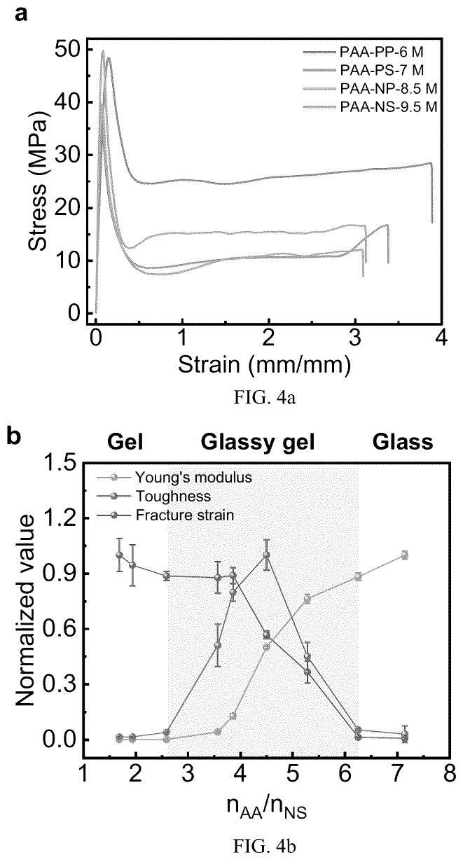

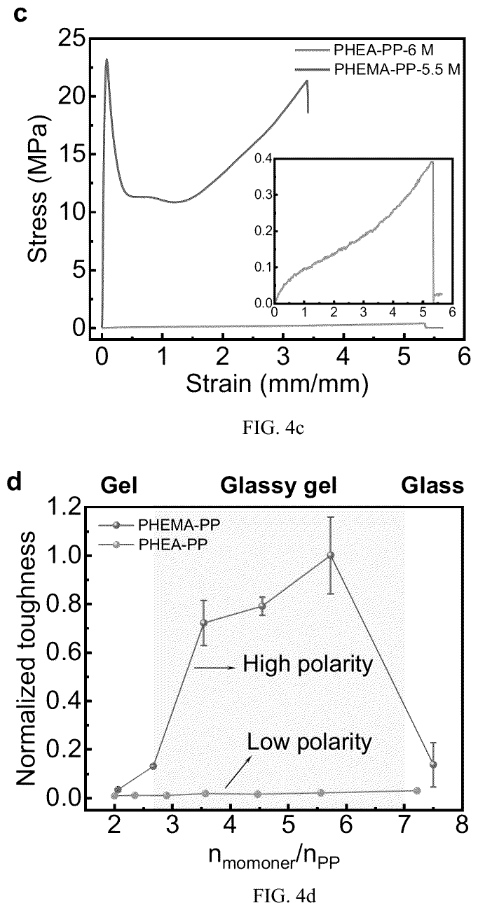

Example 1 was repeated using AA as the monomer, and alternatively tributyl(methyl)phosphonium methyl sulfate (PS), 1-ethyl-3-methylimidazolium dimethyl phosphate (NP), and 1-ethyl-3-methylimidazolium ethyl sulfate (NS) as the ionic liquid to produce samples of PAA-PS-7 M, PAA-NP-8.5 M and PAA-NS-9.5 M. Example 1 was also repeated with the AA monomer, NS ionic liquid, with the ratio of moles of AA to moles of NS (n_{AA}/n_{NS}) ranging from below 2 to over 7. FIG. 4a is a graph showing tensile stress-strain curves of PAA gels with different ionic liquids. The tensile stress-strain curves show that each sample, PAA-PS-7 M, PAA-NP-8.5 M and PAA-NS-9.5 M, is tough and glassy. FIG. 4b is graph showing the normalized Young's modulus, fracture strain, and toughness of each sample as a function of the molar ratio of monomer (AA) to IL solvent (NS), n_{AA}/n_{NS}.

### Example 5

Example 1 was repeated with the AA monomer replaced with 2-hydroxyethyl acrylate (HEA) or 2-hydroxyethyl methacrylate (HEMA) to produce samples of PHEA-PP-6 M and PHEMA-PP-5.5 M. FIG. 4c is a graph showing the tensile stress-strain curves of PHEA-PP-6 M and PHEMA-PP-5.5 M. Inset is the zoom in of the tensile curve of the PHEA-PP-6 M sample. FIG. 4d is a graph of the normalized toughness of PHEA-PP and PHEMA-PP gels as a function of the molar ratio of monomer to PP (nₘₒₙₒₘₑᵣ/n_{PP}). To make a clear comparison, both PHEA-PP and PHEMA-PP samples are normalized based on the maximum toughness of PHEMA-PP sample. In FIG. 4b and FIG. 4d, the mechanical behavior of the samples varies from soft and stretchable (gel-like), stiff and tough (glassy gel), to stiff and brittle (glass-like) as the molar ratio changes.

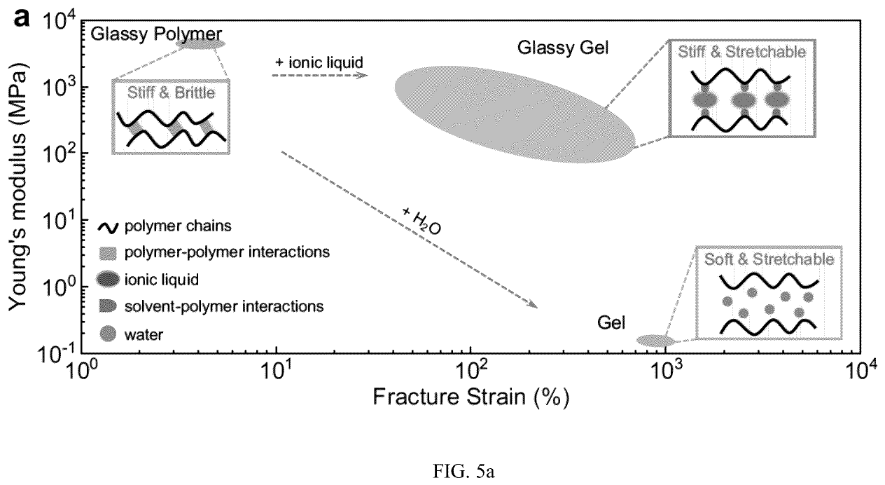

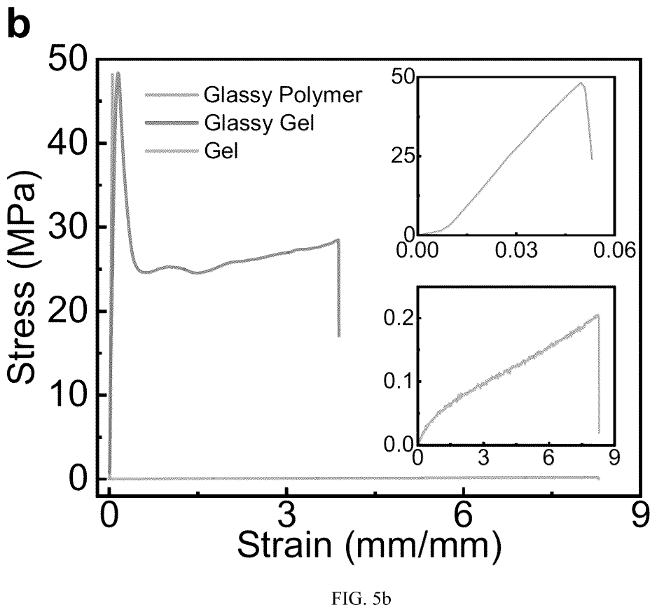

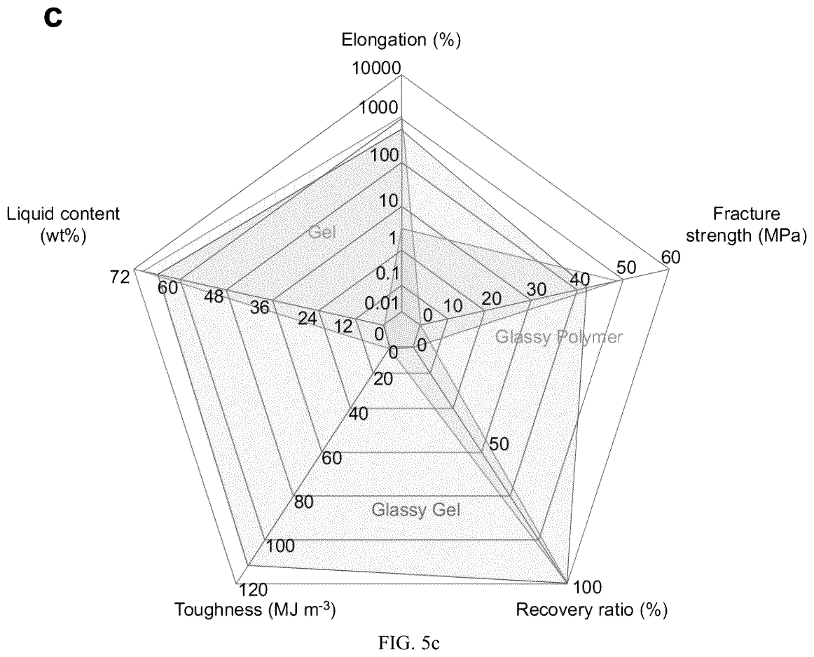

FIG. 5a is a schematic drawing comparing the Young's modulus and fracture strain for a glassy polymer, a glassy gel, and a gel. Adding solvent improves extensibility of glassy polymers, but usually weakens the mechanical properties (e.g., hydrogel). In contrast, glassy gel is extensible like a gel, but stiff like the glassy polymer due to strong solvent-polymer interactions that non-covalently crosslink the polymer. Insets show individual tensile stress-strain curves. FIG. 5b is a graph of the stress-strain curves for PAA-PP-6M glassy gel, PAA glassy polymer, and PAA-Water-6M gel made in Example 1. In the absence of solvent, the polymer is glassy and stiff, yet brittle. Swelling in water produces a hydrogel (≈56 wt. % water) that is many orders of magnitude softer, weaker, and extensible than the glassy polymer. In contrast, replacing water with an ionic liquid solvent (≈58 wt. % IL) the glassy gel is nearly as stiff as a glass polymer, while maintaining extensibility of a gel. FIG. 5c is a spider plot summary in terms of liquid content, toughness, recovery, fracture strength, and elongation.

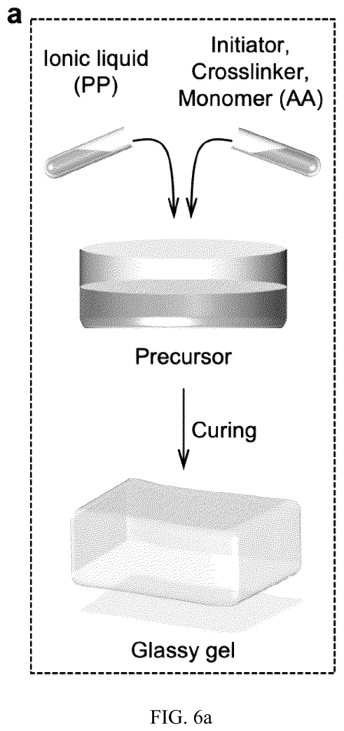

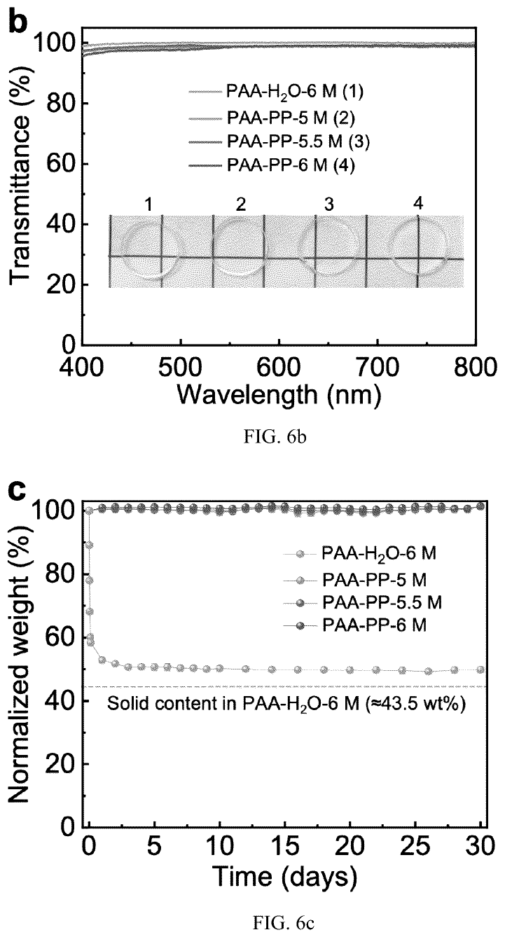

FIG. 6a is a schematic drawing of a non-limiting process for making PAA-PP glassy gels. The ionic liquid (PP) is mixed with a solution containing monomer (AA), initiator, and crosslinker to form a precursor. The precursor is cured to from the glassy gel. FIG. 6b is a graph of transmission of various gels. FIG. 6c is a graph of normalized weight over a period of thirty days for various gels. The graph shows that the glassy gels maintain most of their weight (little solvent loss) whereas the hydrogel lost most of its water over the thirty days.

The example glassy gels presented herein were made via dissolving a monomer in an ionic liquid and initiating free radical polymerization. Without being bound by any theory, the glassy gel fundamentally takes its properties from the interaction of the polymer and the ionic liquid and is independent of the route by which the polymer is made. Non-limiting examples of how polymers may to made for use in glassy gels include free radical polymerization, anionic polymerization, cationic polymerization, atom transfer radical polymerization (ATRP), and condensation polymerization.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A glassy gel comprising:
a) a polymer; and
b) an ionic liquid,
wherein the glassy gel has a toughness greater than 10 MJ/m³, and
wherein the glassy gel is homogeneous at room temperature.

2. The glassy gel of claim 1, wherein the polymer comprises residues of a monomer, and wherein the monomer is soluble in the ionic liquid.

3. The glassy gel of claim 2, wherein the polymer further comprises, a crosslinker, a filler, and/or residues of a polymerization initiator.

4. The glassy gel of claim 2, wherein the monomer comprises acrylic acid (AA), 2-hydroxyethyl methacrylate (HEMA), acrylamide (AAm), and/or N,N-dimethylacrylamide (DMAAm).

5. The glassy gel of claim 1, wherein the ionic liquid comprises a phosphonium-based ionic liquid, an imidazolium-based ionic liquid, a pyridinium-based ionic liquid, a pyrrolidinium-based ionic liquid, and/or a quaternary ammonium-based ionic liquid.

6. The glassy gel of claim 1, wherein the ionic liquid is hydrophobic and comprises a fluorinated ionic liquid.

7. The glassy gel of claim 3, wherein the crosslinker comprises N, N′-methylenebis(acrylamide) (MBAA), and/or wherein the polymerization initiator comprises 2-hydroxy-4′-(2-hydroxyethoxy)-2-methylpropiophenone.

8. The glassy gel of claim 2, wherein a molar ratio of the monomer to the ionic liquid, nₘ:nᵢₗ, ranges from 2:1 to 6:1.

9. The glassy gel of claim 1, wherein the glassy gel comprises 40 wt. % to 70 wt. % of the ionic liquid on a total glassy gel weight basis.

10. The glassy gel of claim 1, wherein the toughness ranges from 10 MJ/m³ to 110 MJ/m³.

11. The glassy gel of claim 1, wherein the glassy gel has a fracture strength ranging from 5 MPa to 42 MPa, wherein the glassy gel has a yield strength ranging from 5 MP to 95 MP, and wherein the glassy gel has a Young's modulus ranging from 50 MPa to 1 GPa.

12. The glassy gel of claim 1, wherein the glassy gel can be strained by a stress, wherein the strain can reach up to 100%, and wherein the glassy gel returns to its original shape after the stress is removed and the glassy gel is subjected to 80° C. for at least one minute.

13. The glassy gel of claim 1, wherein the glassy gel has adhesive properties, shape memory properties, and/or self-healing properties.

14. A glassy gel comprising:
a) an ionic liquid;
b) a residue of a monomer; and
c) a residue of a polymer initiator,
wherein the glassy gel has a toughness greater than 10 MJ/m³,
wherein the monomer comprises acrylic acid (AA), 2-hydroxyethyl methacrylate (HEMA), acrylamide (AAm), and/or N,N-dimethylacrylamide (DMAAm), and wherein the ionic liquid comprises a phosphonium-based ionic liquid, an imidazolium-based ionic liquid, pyridinium-based ionic liquid, a pyrrolidinium-based ionic liquid, and/or a quaternary ammonium-based ionic liquid.

15. The glassy gel of claim 14, wherein the monomer comprises acrylic acid (AA) and/or 2-hydroxyethyl methacrylate (HEMA), and the ionic liquid comprises tributyl(methyl)phosphonium dimethyl phosphate (PP), tributyl(methyl)phosphonium methyl sulfate (PS), 1-ethyl-3-methylimidazolium dimethyl phosphate (NP), and/or 1-ethyl-3-methylimidazolium ethyl sulfate (NS).

16. The glassy gel of claim 14, wherein a molar ratio of the monomer to the ionic liquid, nₘ:nᵢₗ, ranges from 2:1 to 6:1, and
wherein the glassy gel comprises 40 wt. % to 70 wt. % of the ionic liquid on a total glassy gel weight basis.

17. The glassy gel of claim 14, wherein the toughness ranges from 10 MJ/m³ to 110 MJ/m³, wherein the glassy gel has a fracture strength ranging from 5 MPa to 42 MPa, wherein the glassy gel has a yield strength ranging from 5 MP to 95 MP, and wherein the glassy gel has a Young's modulus ranging from 50 MPa to 1 GPa.

18. The glassy gel of claim 14, wherein the glassy gel can be strained by a stress, wherein the strain can reach up to 100%, and wherein the glassy gel returns to its original shape after the stress is removed and the glassy gel is subjected to 80°0 C. for at least one minute.

19. The glassy gel of claim 14, wherein the glassy gel has adhesive properties, shape memory properties, and/or self-healing properties.

20. A process for making a glassy gel, the process comprising:
a) combining a monomer, a polymerization initiator and an ionic liquid to form a solution; and
b) applying an activator of the polymerization initiator to the solution,
wherein the glassy gel has a toughness greater than 10 MJ/m³, and
wherein the glassy gel is homogeneous at room temperature.
